(19) United States
(12) Patent Application Publication
(10) Pub. No.: US 2017/0237112 A1
(43) Pub. Date: Aug. 17, 2017

(54) POROUS SPACERS FOR ELECTROCHEMICAL CELLS

(71) Applicant: 24M Technologies, Inc., Cambridge, MA (US)

(72) Inventors: Richard HOLMAN, Wellesley, MA (US); Naoki OTA, Lexington, MA (US)

(21) Appl. No.: 15/412,380

(22) Filed: Jan. 23, 2017

Related U.S. Application Data
(60) Provisional application No. 62/281,410, filed on Jan. 21, 2016.

(51) Int. Cl. H01M 10/04; H01M 10/6562; H01M 10/48; H01M 10/613; H01M 2/16; H01M 10/0525

(52) U.S. Cl. CPC H01M 10/0481; H01M 2/1646; H01M 2/1653; H01M 10/0525; H01M 10/486; H01M 10/613; H01M 10/6562

(57) ABSTRACT

Embodiments described herein generally relate to porous spacers for applying a preload on one or more electrochemical cells disposed in a battery pack. In some embodiments, a battery pack can include a plurality of electrochemical cells. A porous spacer is disposed between each of the plurality of electrochemical cells such the porous spacer can be centrally located with respect to the mid-point of adjacent electrochemical cells. The porous spacer can be sized and shaped to contact in the range of about 50% to about 100% of a surface area of each adjacent electrochemical cell such that the porous spacer exerts a preload on a central portion or any combination of predetermined area of the electrochemical cell.

### CROSS-REFERENCE TO RELATED APPLICATIONS

This application claims priority to and the benefit to U.S. Provisional Application No. 62/281,410, filed on Jan. 21, 2016, entitled, “POROUS SPACERS FOR ELECTROCHEMICAL CELL,” the disclosure of which is incorporated by reference herein in its entirety.

### BACKGROUND

Embodiments described herein relate generally to a battery pack that includes a plurality of electrochemical cells that are separated by a porous spacer or a plurality of porous spacers which are configured to apply a preload on at least a portion of electrochemical cells included in the battery pack.

Some known electrochemical cells such as, for example, lithium-ion cells require continuous contact between the layers of the battery architecture (e.g., the current collector, anode, cathode, and separator) to achieve optimal performance and long life. In cylindrical “can” cells, this contact is maintained via a large normal force (“stack pressure”) that is generated as a result of swelling of the electrodes and the hoop stress this creates due to wound nature of the structure. Prismatic cells such as, for example, pouch type prismatic cells lack this inherent advantage due to their “flattened” structure. Even wound prismatic cells are unable to develop any significant hoop stress which can provide the desired stack pressure.

### SUMMARY

Embodiments described herein generally relate to porous spacers for applying a preload on one or more electrochemical cells disposed in a battery pack. In some embodiments, a battery pack can include a plurality of electrochemical cells. A porous spacer is disposed between each of the plurality of adjacent electrochemical cells. The porous spacer can be sized and shaped to contact in the range of about 50% to 100% of a surface area of each adjacent electrochemical cell such that the spacer exerts a preload on at least a portion of the electrochemical cell. In some embodiments, the porous spacer can be formed from steel wool or stainless steel wool. In some embodiments, the porous spacer can have a hole for placement of a heat-sensing device such as, for example, a thermocouple.

### BRIEF DESCRIPTION OF THE DRAWINGS

FIG. 1 shows a schematic block diagram of a battery pack, according to an embodiment.

FIG. 2 shows a schematic illustration of a porous spacer disposed between a first electrochemical cell and a second electrochemical cell, according to an embodiment.

FIG. 3 shows a side cross-section of the first electrochemical cell of FIG. 2 disposed on the second electrochemical cell of FIG. 2 with the porous spacer disposed therebetween.

FIG. 4 shows a schematic illustration of a plurality of porous spacers disposed between a first electrochemical cell and a second electrochemical cell, according to an embodiment.

FIG. 5 shows a side cross-section of the first electrochemical cell of FIG. 4 disposed on the second electrochemical cell of FIG. 4 with the porous spacers disposed therebetween.

FIG. 6 shows a schematic illustration of a porous spacer, which includes a temperature sensor disposed therein, disposed between a first electrochemical cell and a second electrochemical cell, according to an embodiment.

FIG. 7 shows a side cross-section of the first electrochemical cell of FIG. 6 disposed on the second electrochemical cell of FIG. 6 with the porous spacer disposed therebetween.

### DETAILED DESCRIPTION

Battery packs formed from electrochemical cells such as, for example, prismatic pouch cells and prismatic can cells, generally include a plurality of electrochemical cells disposed in a stack with a spacer disposed between adjacent electrochemical cells. The spacers are configured to exert a preload on the adjacent electrochemical cells to prevent the electrochemical cells from expanding due to gas generation. This expansion can cause delamination of the layers included in the electrochemical cell, for example, the separation of the electrodes from the current collectors. This primarily happens at a central portion of the electrochemical cells such that the electrochemical cells bulge outward. Spacers included in conventional battery packs are generally solid spacers that are sized and shaped to contact substantially the entire exterior surface of a side wall of the electrochemical cell. This blocks paths of heat transfer between adjacent electrochemical cells which can lead to overheating, degradation and/or catastrophic failure of the electrochemical cells.

Some prismatic pouch cells (“soft pack”) are vacuum sealed around the electrochemical cell stack that provides some benefit in terms of stack pressure. However, any advantage can be lost relatively easily due to gas generation within the layers of electrochemical cells during the normal operation of the electrochemical cell. Some pouch electrochemical cells (also known as “polymer cells”) employ a gel electrolyte to bond the anode and/or cathode layers of the electrochemical cell to the separator. This, however, can have the disadvantage of increased cell impedance, increased cost and complexity of cell assembly. Therefore, where performance is particularly critical such as, for example, in large, multi-cell systems, mechanical methods have been developed to maintain the necessary stack pressure and interlayer pressure. For example, a stack of individual prismatic cells are often disposed one on top of the other (i.e., in a stack) between a set of rigid plates. Band straps and/or tie rods are further used to apply a compressive load on the plates to apply the stack pressure on each electrochemical cell.

In the case of prismatic pouch cells, such mechanical methods often include pliable spacer layers (e.g., foam sheets) disposed between each of the prismatic pouch cells included in the battery pack to distribute the load evenly over the surface of the soft prismatic pouch cell and apply a compressive load (also referred to herein as “preload”). These foam spacers tend to be expensive and can also be poor heat conductors. Therefore, such battery packs often include complex cooling structures between the pouch prismatic cells such as, for example, fins. The foam sheets preclude simple air cooling across the surfaces of the prismatic pouch cells and can also make the monitoring of electrochemical cell temperature at a region of interest (e.g., a face of an electrochemical cell) much more difficult.

In the case of prismatic can cells that include a rigid exterior enclosure (i.e. the “can”), some benefit can be achieved by forming structures in the walls of the enclosure for applying a pre-load to the stack of electrochemical cells. This is however, generally limited to relatively small cells (e.g., of the type used in portable electronics) because sufficient pressure cannot be achieved in large area electrochemical cells with such structures (e.g., area greater than about 20 cm²). Such prismatic can cells can be disposed in a stack included in a battery pack, such that each prismatic can cell applies a compressive load on the other prismatic can cell. Such an arrangement, however, creates additional complexity because the ends and sidewalls of the prismatic can cells are generally very rigid, and therefore support the majority of the applied load. This limits the load applied to the face of the prismatic can cells, thereby limiting the load on the electrode stack included in the prismatic can cell. Such unequal load distribution can potentially damage the enclosure of the prismatic can cell. Moreover, known prismatic can cells often include a space between the enclosure side walls and the electrode stack to allow for assembly tolerances and/or swelling of the electrode stack. In such cases, essentially no load will be applied to the electrodes if pressure is applied over the entire cell area.

Embodiments described herein generally relate to porous spacers for applying a preload on one or more electrochemical cells disposed in a battery pack. In some embodiments, a battery pack can include a plurality of electrochemical cells. A porous spacer is disposed between each of the plurality of electrochemical cells such that the spacer is strategically placed with respect to the design considerations and dimensions of adjacent electrochemical cells. The porous spacer can be sized and shaped to contact in the range of about 50% to 100% of the surface area of each adjacent electrochemical cell such that the spacer exerts a preload on designated portion or portions of the electrochemical cell. In some embodiments, the porous spacer can be formed from steel wool or stainless steel wool. In some embodiments, the porous spacer can have a hole for placement of a heat-sensing device such as, for example, a thermocouple.

Embodiments of the porous spacers described herein that are configured to apply a preload on electrochemical cells disposed in a battery pack provide many benefits including, for example: (1) the porous spacers can be disposed and configured to exert pressure on the areas of the electrochemical cells where deformation due to gas generation is most likely to occur; (2) a substantial portion of the external surface of adjacent electrochemical cells remains exposed to air flow for cooling the electrochemical cells; (3) a temperature sensor can be disposed within the porous spacer to monitor temperature at the most critical location of the electrochemical cells, i.e., the mid-point of the electrochemical cells; (4) the porous spacers can be configured to contact the entire surface area of adjacent electrochemical cells while still providing a path for cooling air to flow through the porous spacer; and (5) because the spacers described herein are porous, these spacers can be relatively light, thereby reducing the overall weight of the battery pack.

As used herein, the term “about” and “approximately” generally mean plus or minus 10% of the value stated, e.g., about 250 μm would include 225 μm to 275 μm, about 1,000 μm would include 900 μm to 1,100 μm.

As used herein, the term “semi-solid” refers to a material that is a mixture of liquid and solid phases, for example, such as particle suspension, colloidal suspension, emulsion, gel, or micelle.

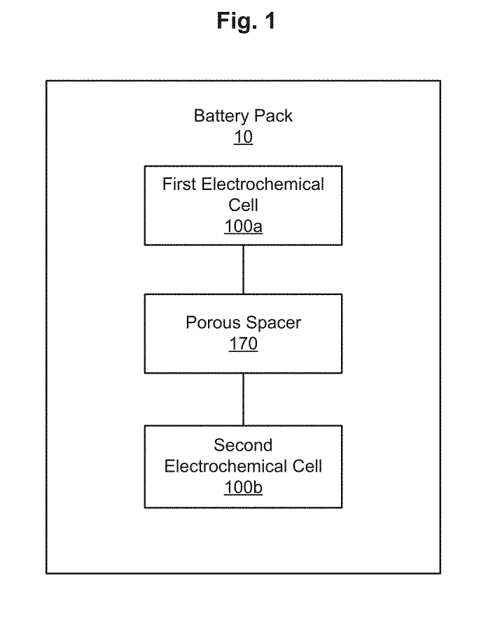

FIG. 1 shows a schematic illustration of a battery pack 10 that includes a first electrochemical cell 100a and a second electrochemical cell 100b (collectively referred to as “the electrochemical cells 100”). A porous spacer 170 is disposed between the first electrochemical cell 100a and the second electrochemical cell 100b, configured to apply a compressive preload on the electrochemical cells 100. While shown as including two electrochemical cells, any number of electrochemical cells can be included in the battery pack 10, and a porous spacer can be disposed between each of the adjacent electrochemical cells.

The electrochemical cells 100 can include a cathode and an anode which are disposed on a positive current collector and a negative current collector, respectively. A separator (e.g., an ion-permeable membrane) is disposed between the positive current collector and the negative current collector. One or more electrode stacks can be included in each of the electrochemical cells 100. In some embodiments, the cathode and/or the anode can be conventional solid anodes. In some embodiments, the cathode and/or anode can be semi-solid anodes and can have a thickness of at least about 250 μm. Examples of electrochemical cells utilizing thick semi-solid electrodes and various formulations thereof are described in U.S. patent application Ser. No. 13/872,613 (also referred to as “the '613 application”), filed Apr. 29, 2013, entitled “Semi-Solid Electrodes Having High Rate Capability,” U.S. patent application Ser. No. 14/202,606 (also referred to as “the '606 application), filed Mar. 10, 2014, entitled “Asymmetric Battery Having a Semi-Solid Cathode and High Energy Density Anode,” and U.S. patent application Ser. No. 14/336,119 (also referred to as “the '119 application”) filed Jul. 21, 2014, entitled “Semi-Solid Electrodes with Gel Polymer Additive”, the entire disclosures of which are hereby incorporated by reference.

Each of the electrochemical cells 100 can be packaged in a suitable container, for example, vacuum sealed in a soft flexible pouch or packaged in a hard can (e.g., a metal can or a plastic can). In some embodiments, the electrochemical cells 100 can be prismatic pouch cells. In some embodiments, the electrochemical cells 100 can be prismatic can cells. In some embodiments, the electrochemical cells 100 can be non-prismatic pouch cells or non-prismatic can cells. For example, the electrochemical cells 100 can be packaged in a container that has one or more surfaces that are curved. Examples of curved containers for packaging electrochemical cells are described in U.S. Provisional Application No. 61/890,562, filed on Oct. 14, 2013, and entitled “Curved Battery Container”, the contents of which are hereby incorporated by reference herein in their entirety. In some embodiments, the electrochemical cells 100 can be round, bent, contoured, dome shaped, or have any other shape or size.

The electrochemical cells 100 can be disposed in a battery pack, for example, stacked one on top of the other, or disposed in a container (e.g., a plastic or metal container), with the porous spacer 170 disposed between the first electrochemical cell 100a and the second electrochemical cell 100b. In some embodiments, the electrochemical cells 100 can be sandwiched between rigid plates and tied together with band straps (e.g., plastic or metal straps) or tie rods.

The porous spacer 170 is disposed between the first electrochemical cell 100a and the second electrochemical cell 100b such that the porous spacer 170 contacts a first side wall of a first container of the first electrochemical cell 100a and a second side wall of a second container of the second electrochemical cell 100b. The porous spacer 170 can be a porous foam spacer, a plastic porous spacer, or a metal porous spacer. The porous spacer 170 can have any suitable shape, for example, prismatic, round, oblong, polygonal, or any other suitable shape. Furthermore, the porous spacer 170 can be shaped to be contiguous with the first side wall of the first container of the first electrochemical cell 100a, or the second side wall of the second container of the second electrochemical cell 100b. In some embodiments, the porous spacer 170 is integrally formed with the first side wall of the first container of the first electrochemical cell 100a and/or the second side wall of the second container of the second electrochemical cell 100b. In some embodiments, the porous spacer 170 can be coupled/attached to the at least one of the first side wall of the first container, or the second side wall of the second container, for example, bolted, riveted, screwed, welded, or adhered via an adhesive. In such embodiments, suitable sealing mechanisms can be used to seal the portion where the coupling mechanism traverses a side wall of the first container or the second container, for example, via a rubber gasket or a sealant. In some embodiment, the porous spacer 170 can be monolithically formed with the first container and/or the second container. For example, the porous spacer 170 can be molded into the first side wall of the first container and/or the second side wall of the second container.

In some embodiments, the porous spacer 170 can be a centrally located spacer. In such embodiments, the porous spacer 170 can be disposed at central location between the electrochemical cells 100 such that a mid-point of the spacer 170 is substantially adjacent to a mid-point of each of the electrochemical cells 100. The porous spacer 170 can be dimensioned such that the porous spacer 170 contacts at least about 5% of the surface area of the first side wall of the first container of the first electrochemical cell 100a and the second side wall of the second container of the second electrochemical cell 100b. For example, the porous spacer 170 can be dimensioned such that the porous spacer 170 contacts about 50%, about 55%, about 60%, about 65%, about 70%, about 75%, about 80%, about 85%, about 90%, about 95%, or about 100% of the surface area of the first side wall of the first container of the second side wall of the second container. And yet a substantial portion of the surface of each of the container of the electrochemical cells 100 remains exposed to air flow and/or coolant flow due to the porous nature of the spacer(s), thereby facilitating cooling of the electrochemical cells 100.

In some embodiments, the porous spacer 170 can include a centrally located spacer as described herein and a plurality of secondary porous spacers (not shown) surrounding the centrally located porous spacer. The secondary porous spacers can be arranged in an array (e.g., a rectangular array, a circular array, a staggered array, etc.) surrounding the secondary located porous spacer. The secondary porous spacers can be configured to exert an additional preload on the electrochemical cells 100 in the regions surrounding the central portion of the electrochemical cells 100. The secondary porous spacers can be formed from the same material as the centrally located porous spacer or from a different material. Moreover, the secondary porous spacers can have the same shape as the centrally located porous spacer or a different shape. The secondary porous spacers can have a smaller dimension (e.g., length, width, diameter, or otherwise cross-section) relative to the centrally located porous spacer. In some embodiments, the centrally located porous spacers and/or the secondary porous spacers can be monolithically formed with the first side wall of the first container of the first electrochemical cell 100a and/or the second side wall of the second container of the second electrochemical cell 100b. The secondary porous spacers can be spaced apart such that there is sufficient space between adjacent secondary spacers to allow air flow (or coolant flow). Thus, the secondary porous spacers can provide additional preload on the electrochemical cells 100 without affecting heat transfer from the side walls of the electrochemical cells 100.

In some embodiments, the porous spacer 170 can include a centrally located porous spacer that can include a cavity for housing a temperature sensor. This can allow for placement of the temperature sensor at a central location relative to the electrochemical cells 100, where the most accurate and pertinent readings of the temperature of the electrochemical cells 100 can be obtained. Furthermore, in such embodiments, the temperature sensor can be adjacent to the side walls of the electrochemical cells 100, and therefore obtain the most accurate readings. The temperature sensor can include, for example, a temperature probe, a thermocouple, or a thermistor. The temperature sensor can be connected via a lead to a temperature gage for displaying a temperature of the electrochemical cells 100. In some embodiments, the temperature sensor can be in communication with feed back electronic circuitry that can disengage the first electrochemical 100a, and/or the second electrochemical 100b from a load, if the temperature exceeds a predetermined threshold.

In some embodiments, the porous spacer 170 can be disposed on about 50%, 55%, 60%, 65%, 70%, 75%, 80%, 85%, 90%, 95%, or about 100% of the surface area of the side walls of the electrochemical cells 100 inclusive of all ranges and values therebetween. The porous spacer 170 can be formed from an elastic and/or flexible material that can apply a preload on the electrochemical cells 100. For example, in some embodiments, the porous spacer 170 can include steel wool or stainless steel wool. In some embodiment, the porous spacer 170 can be formed from a porous elastic polymer. The porosity of the porous spacer 170 can allow air to flow into the pores and over the side walls of the electrochemical cells 100, thereby allowing effective heat transfer from the side walls of the containers of the electrochemical cells 100, at the same time applying a compressive load on a large surface of the electrochemical cells 100.

In some embodiments, the porosity of the porous spacer 170 can be random. Said another way, the porous spacer 170 can have an irregular porosity throughout the porous structure of the porous spacer 170. In some embodiments, the porosity of the porous spacer 170 can be pre-arranged so as to form a periodic porous structure within the porous spacer 170. Said another way, the porous spacer 170 can have a grid-like porous structure or periodic arrangement in porous structures throughout, or a portion of, the porous spacer 170. In some embodiments, the porous spacer 170 can include a randomized porosity in some portions of the porous spacer 170 and ordered periodic porous structures in other portions of the porous spacer 170. The ratio and placement of the random and ordered porous structures within the porous spacer 170 can be specifically engineered.

Having described above various general principles, several exemplary embodiments of these concepts are now described. These embodiments are only examples, and many other configurations of spacers for exerting a preload on electrochemical cells disposed in a battery pack, are contemplated.

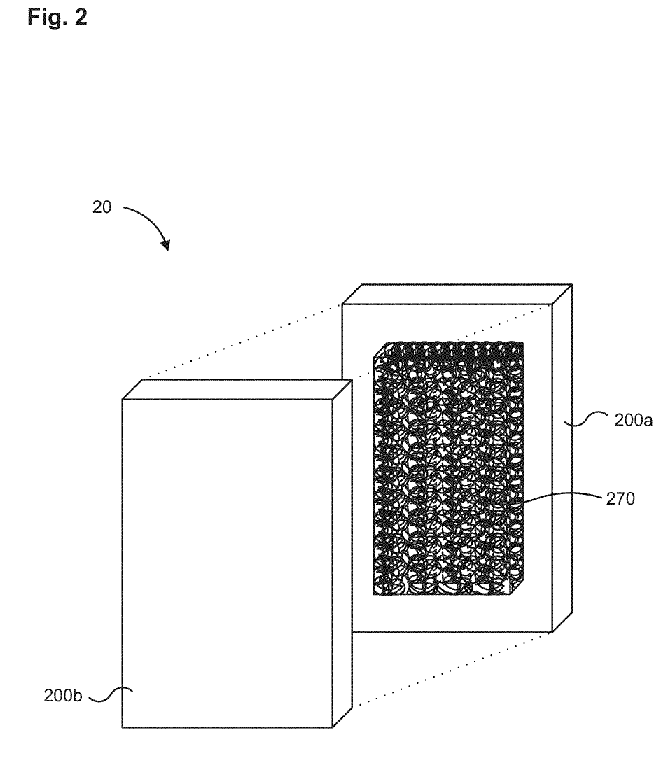

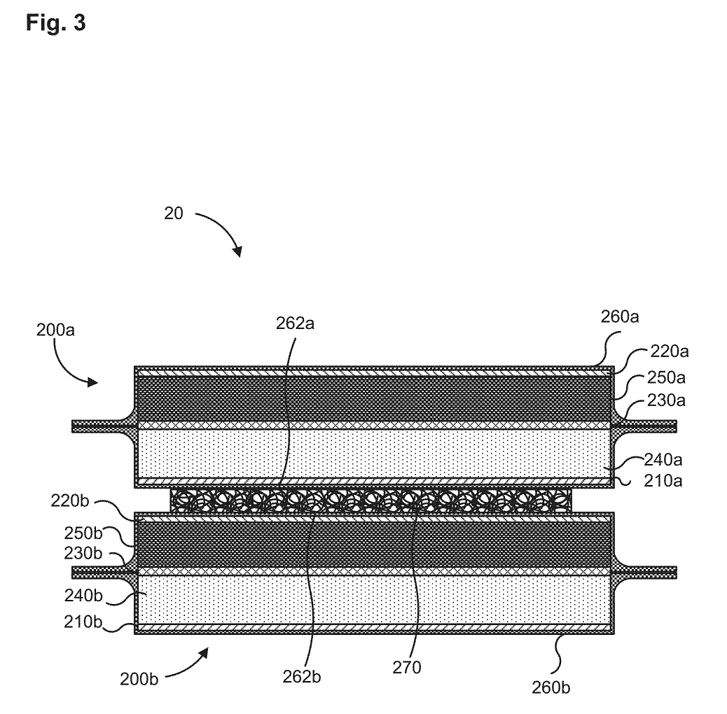

In some embodiments, a battery pack can include centrally located porous spacers. Referring now to FIGS. 2 and 3, a battery pack 20 includes a first electrochemical cell 200a and a second electrochemical cell 200b. A porous spacer 270 is disposed between the first electrochemical cell 200a and the second electrochemical cell 200b. While shown as having only two electrochemical cells, the battery pack 20 can include any number of electrochemical cells and the porous spacer 270 can be disposed between each of the plurality of electrochemical cells included in the battery pack 20.

As shown in FIG. 3, the first electrochemical cell 200a includes a positive current collector 210a and a negative current collector 220a. The positive current collector 210a and the negative current collector 220a can be any suitable current collector. The current collectors can be formed from any suitable material, for example, copper, aluminum, titanium, any other suitable material or combination thereof, and can be in the form of a sheet or a mesh. A cathode 240a is disposed on the positive current collector 210a and an anode 250a is disposed on the negative current collector 220a. The cathode 240a can be a conventional solid cathode or a semi-solid cathode. Similarly, the anode 250a can be a conventional solid anode, a conventional high capacity solid anode, or a semi-solid anode. A separator 230, for example, an ion-permeable membrane is disposed between the cathode 240a and the anode 250a. While shown as being disposed on only one side, the cathode 240a and the anode 250b can be disposed on both sides of the positive collector 210a and the negative collector 220a, respectively. Furthermore, while shown as having a single electrochemical cell, the first electrochemical cell 200a can include an electrochemical cell stack (i.e., a plurality of active and inactive layers), which can include any number of electrochemical cells. The first electrochemical cell 200a is enclosed in a first container 260a. The container 260a can be a prismatic pouch or a prismatic can. While shown as being a prismatic container, in some embodiments, the container 260a can be a curved container, a bent container, or have any other shape.

The porous spacer 270 is disposed between the first electrochemical cell 200a and the second electrochemical cell 200b. The porous spacer 270 contacts an external surface of a first side wall 262a of the first container 260a and a second side of the porous spacer 270 contacts an external surface of a second side wall 262b of the second container 260b. The spacer 270 can be formed from a rigid material, for example, foam, rubber, hard plastic, metal, any other suitable material or combination thereof. The porous spacer 270 can have a prismatic shape similar to the shape of the electrochemical cells. In some embodiments, the porous spacer 270 can have any suitable shape, for example square, round, oblong, elliptical, polygonal, or any other suitable shape to conform. In some embodiments, the porous spacer 270 can be flexible so that the spacer can conform to a contour of the first side wall 262a and the second side wall 262b. In some embodiments, the porous spacer 270 can be coupled to the first side wall 262a of the first container 260a and/or the second sidewall 262b of the second container 260b. For example, the porous spacer 270 can be screwed, riveted, bolted, welded, or bonded with an adhesive. In some embodiments, the porous spacer 270 can be monolithically formed in a side wall (e.g., first side wall 262a or second side wall 262b) of at least one of the first container 260a or the second container 260b.

The porous spacer 270 is disposed at a central location in between the first electrochemical cell 200a and the second electrochemical cell 200b, and is configured to exert a compressive load on a central portion of the first electrochemical cell 200a and the second electrochemical cell 200b. The porous spacer 270 can be disposed such that a mid-point of the porous spacer 270 is substantially aligned with the mid-point of the first electrochemical cell 200a and the second electrochemical cell 200b. Moreover, the porous spacer 270 is dimensioned such that porous spacer 270 contacts in the range of about 50% to about 100% of an external surface area of the first side wall 262a of the first container 260a and the second side wall 262b of the second container 260b. For example, the porous spacer 270 can have a size such that it contacts about 50%, about 55%, about 60%, about 65%, about 70%, about 75%, about 80%, about 85%, about 90%, about 95%, or about 100%, inclusive of all ranges therebetween, of the external surface of the first side wall 262a and the second side wall 262b.

Since the maximum deflection in the electrochemical cells due to gas generation generally occurs in the central portion of the electrochemical cell, the centrally located porous spacer 270 can limit this expansion by applying the compressive force on the central portion of the first electrochemical cell 200a and the second electrochemical cell 200b. Moreover, since the porous spacer 270 has a smaller surface area than the electrochemical cells, the porous spacer 270 does not contact the entire surface area of the electrochemical cells. Thus a substantial portion of the external surface area of the first side wall 262a and the second side wall 262b can still be exposed to air flow or coolant flow. This can allow for efficient heat transfer from the first electrochemical cell 200a and the second electrochemical cell 200b without the need of complex heat transfer schemes, while maintaining an efficient preload on the adjacent electrochemical cells.

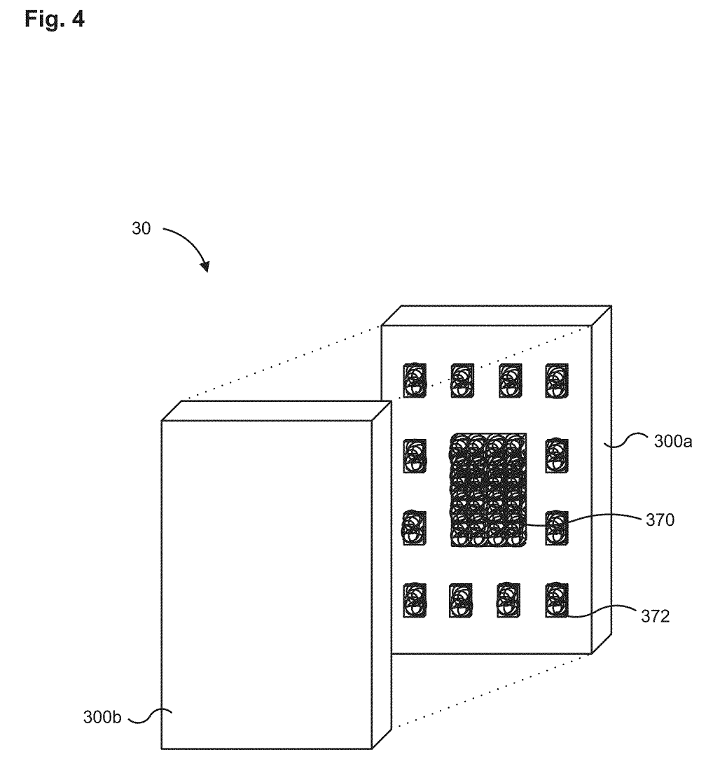

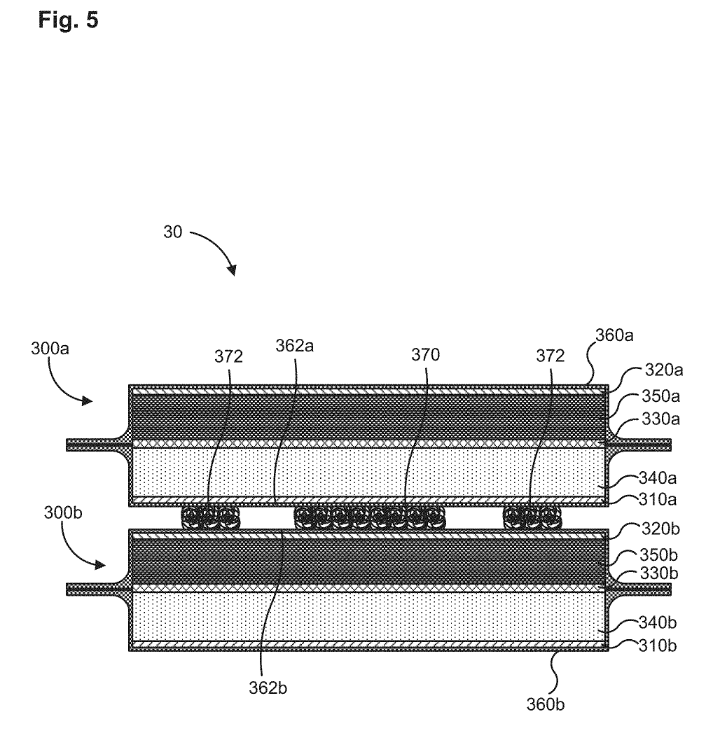

In some embodiments, a battery pack can include a centrally located porous spacer and a plurality of secondary porous spacers. Referring now to FIGS. 4 and 5, a battery pack 30 includes a first electrochemical cell 300a and a second electrochemical cell 300b. A first porous spacer 370 is disposed between the first electrochemical cell 300a and the second electrochemical cell 300b. A plurality of secondary porous spacers 372 are also disposed between the first electrochemical cell 300a and the second electrochemical cell 300b. While shown as having only two electrochemical cells, the battery pack 30 can include any number of electrochemical cells such that the first porous spacer 370 and the plurality of secondary porous spacers 372 are disposed between each of the plurality of electrochemical cells included in the battery pack 30.

As shown in FIG. 5, the first electrochemical cell 300a includes a positive current collector 310a and a negative current collector 320a. A cathode 340a is disposed on the positive current collector 310a and an anode 350a is disposed on the negative current collector 320a. A separator 330a is disposed between the cathode 340a and the anode 350a. The electrochemical cell 300a can be substantially similar to the first electrochemical cell 200a described with respect the battery pack 20, and therefore, not described in further detail herein. The electrochemical cell 300a is enclosed in a container 360b which can be substantially similar to the container 260a described with respect to the battery pack 20, and therefore not described in further detail herein.

The second electrochemical cell 300b includes a positive current collector 310b and a negative current collector 320b. A cathode 340b is disposed on the positive current collector 310b and an anode 350b is disposed on the negative current collector 320b. A separator 330b is disposed between the cathode 340b and the anode 350b. The electrochemical cell 300b can be substantially similar to the first electrochemical cell 200a described with respect to the battery pack 20, and therefore, not described in further detail herein. The electrochemical cell 300b is enclosed in a container 360b which can be substantially similar to the container 260a described with respect to the battery pack 20, and therefore not described in further detail herein.

The first porous spacer 370 is disposed between the first electrochemical cell 300a and the second electrochemical cell 300b. The first porous spacer 370 contacts an external surface of a first side wall 362a of the first container 360a and a second side of the first porous spacer 370 contacts an external surface of a second side wall 362b of the second container 360b. The first porous spacer 370 is disposed at a central location in between the first electrochemical cell 300a and the second electrochemical cell 300b, and is configured to exert a compressive load on and around a central portion of the first electrochemical cell 300a and the second electrochemical cell 300b. The first porous spacer 370 can be substantially similar to the porous spacer 270 described with respect to the battery pack 20 and is therefore, not described in further detail herein.

The plurality of the secondary porous spacers 372 are disposed between the first electrochemical cell 300a and the second electrochemical cell 300b surrounding the centrally located first porous spacer 370. The secondary porous spacers 372 can be arranged in an ordered array surrounding the centrally located porous spacer 370. While shown as being arranged in a rectangular array with only two rows and two columns, any number of secondary porous spacers 372 can be arranged in a rectangular array having any numbers of rows or columns. In some embodiments, the secondary porous spacers 372 can be disposed in a circular array, a staggered array, or any other suitable array. Each of the plurality of secondary porous spacers 372 is in contact with the first side wall 362a of the first container 360 and the second side wall 362b of the second container 360b. The plurality of secondary porous spacers 372 are configured to exert a compressive load at various locations over the surface of the first electrochemical cell 300a and the second electrochemical cell 300b, that are not in contact with the centrally located first porous spacer 370. Thus, the secondary porous spacers 372 can provide additional preload to the electrochemical cells offering better resistance to electrochemical cell expansion and failure. As shown in FIG. 3 the first porous spacer 370 and the plurality of porous spacers 372 have a prismatic shape. In some embodiments, the first porous spacer 370 and/or the plurality of secondary porous spacers 372 can have any other shape, for example, square, circular, oblong elliptical, polygonal, any other suitable shape or combination thereof. The secondary porous spacers 372 can be made from any suitable rigid material, for example, foam, rubber, hard plastic, metals, any other suitable material or a combination thereof. In some embodiments, the plurality of secondary spacers can be coupled/attached to the first surface 362a of the first container 360a or the second surface 362b of the second container 360b. For example, the secondary porous spacers 372 can be screwed, riveted, bolted, welded, bonded with an adhesive, or coupled/attached using any other suitable method or combination thereof. In some embodiments, the plurality of secondary porous spacers 372 can be monolithically formed in the first side wall 362a of the first container 360a and/or the second side wall 362b of the second container 360b, for example, in a single molding or stamping step.

In some embodiments, the first porous spacer 370 and the secondary porous spacers 372 can have the same shape. In some embodiments, the first porous spacer 370 and the second porous spacer 372 can have different shapes. Each of the plurality of porous spacers 372 can have a size, for example, a length, a width, a cross-section, or otherwise a cross-sectional area substantially smaller than the centrally located first porous spacer 370. The plurality of secondary porous spacers 372 can be spaced apart such that a substantial portion of the external surface of the first side wall 362a of the first container 360a and the second side wall 362b of the second container 360b is exposed to air flow or coolant flow. Thus, the plurality of secondary porous spacers 372 can provide additional compressive load on the surfaces of the first electrochemical cell 300a and the second electrochemical cell 300b while still allowing sufficient heat transfer to occur.

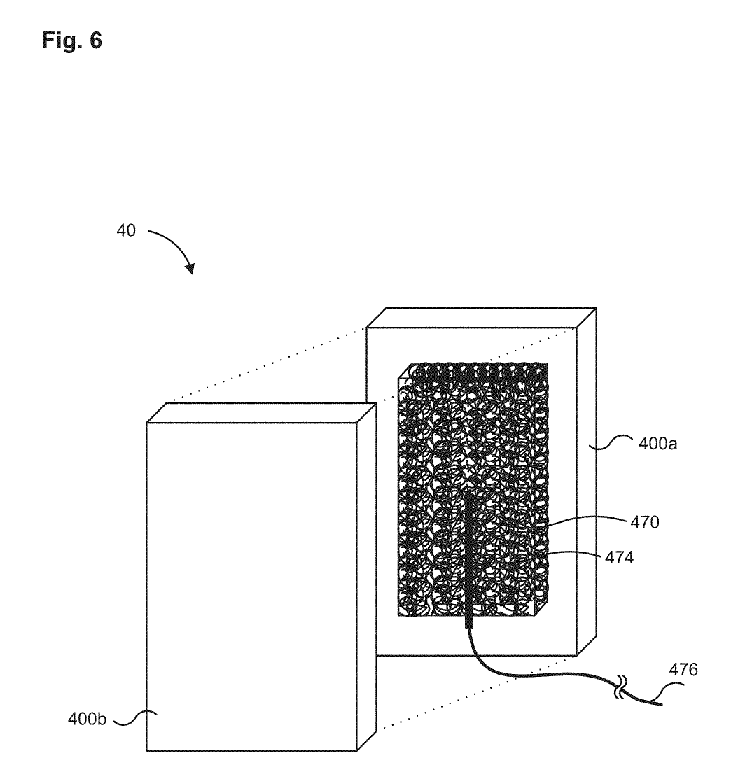

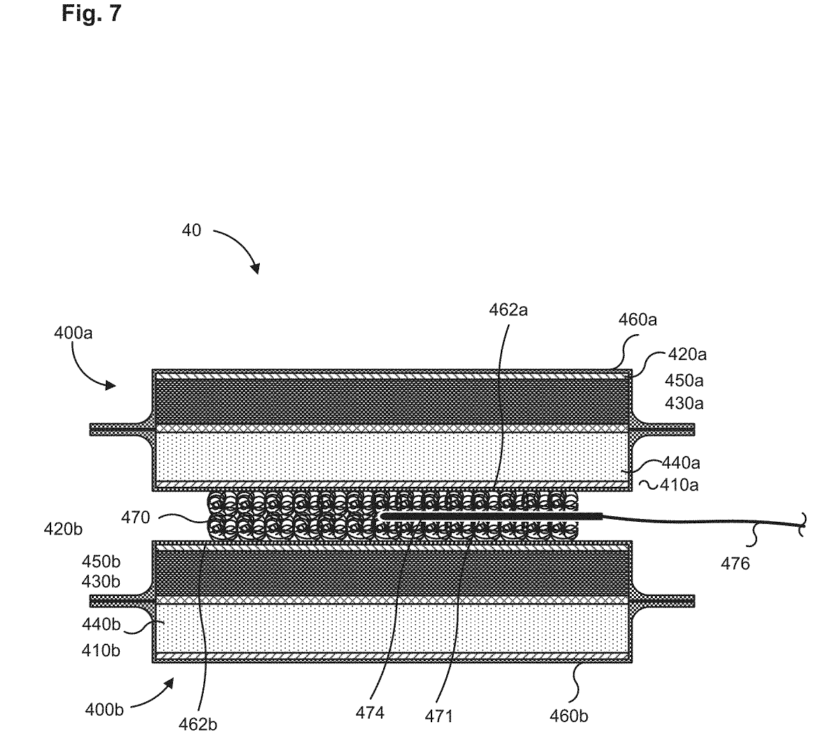

In some embodiments, a battery pack can include a centrally located spacer which includes a temperature sensor. Referring now to FIGS. 6 and 7, a battery pack 40 includes a first electrochemical cell 400a and a second electrochemical cell 400b. A porous spacer 470 is disposed between the first electrochemical cell 400a and the second electrochemical cell 400b. While shown as having only two electrochemical cells, the battery pack 40 can include any number of electrochemical cells and the porous spacer 470 can be disposed between each of the plurality of electrochemical cells included in the battery pack 40.

As shown in FIG. 7, the first electrochemical cell 400a includes a positive current collector 410a and a negative current collector 420a. A cathode 440a is disposed on the positive current collector 410a and an anode 450a is disposed on the negative current collector 420a. A separator 430a is disposed between the cathode 440a and the anode 450a. The electrochemical cell 400a can be substantially similar to the first electrochemical cell 200a described with respect the battery pack 20, and therefore, not described in further detail herein. The electrochemical cell 400a is enclosed in a container 460b which can be substantially similar to the first container 260a described with respect to the battery pack 20, and therefore not described in further detail herein.

The second electrochemical cell 400b includes a positive current collector 410b and a negative current collector 420b. A cathode 440b is disposed on the positive current collector 410b and an anode 450b is disposed on the negative current collector 420b. A separator 430b is disposed between the cathode 440b and the anode 450b. The electrochemical cell 400b can be substantially similar to the first electrochemical cell 200a described with respect to the battery pack 20, and therefore, not described in further detail herein. The electrochemical cell 400b is enclosed in a container 460b which can be substantially similar to the first container 260a described with respect to the battery pack 20, and therefore not described in further detail herein.

The porous spacer 470 is disposed between the first electrochemical cell 400a and the second electrochemical cell 400b. The porous spacer 470 contacts an external surface of a first side wall 462a of the first container 460a and a second side of the porous spacer 470 contacts an external surface of a second side wall 462b of the second container 460b. The porous spacer 270 can be formed from a rigid material, for example, foam, rubber, hard plastic, metal, any other suitable material or combination thereof. The porous spacer 470 can have a prismatic shape similar to the shape of the electrochemical cells. In some embodiments, the porous spacer 470 can have any suitable shape, for example square, round, oblong, elliptical, polygonal, or any other suitable shape. In some embodiments, the porous spacer 470 can be coupled to the first side wall 462a of the first container 460a and/or the second sidewall 462b of the second container 460b. For example, the porous spacer 470 can be screwed, riveted, bolted, welded, or bonded with an adhesive. In some embodiments, the porous spacer 470 can be monolithically formed in a side wall (e.g., the first side wall 462a or the second side wall 462b) of at least one of the first container 460a or the second container 460b.

The porous spacer 470 is disposed at a central location in between the first electrochemical cell 400a and the second electrochemical cell 400b, and is configured to exert a compressive load on and around a central portion of the first electrochemical cell 400a and the second electrochemical cell 400b. The porous spacer 470 can be disposed such that a mid-point of the porous spacer 470 is substantially aligned with the mid point of the first electrochemical cell 400a and the second electrochemical cell 400b. Moreover, the porous spacer 470 is dimensioned such that the porous spacer 470 contacts in the range of about 50% to about 100% of the external surface area of the first side wall 462a of the first container 460a and the second side wall 462b of the second container 460b. For example, the porous spacer 470 can have be dimensioned such that it contacts about 50%, about 55%, about 60%, about 65%, about 70%, about 75%, about 80%, about 85%, about 90%, about 95%, or about 100%, inclusive of all ranges therebetween, of the external surface of the first side wall 462a and the second side wall 462b.

As shown in FIG. 7, the porous spacer 470 includes a cavity 471, sized and shaped to receive a temperature sensor 474. The temperature sensor 474 can include any suitable temperature sensor, for example, a temperature probe, a thermocouple, or a thermistor. The temperature sensor 474 can thus be disposed in proximity of the central portion of each of the first electrochemical cell 400a and the second electrochemical cell 400b, where the most meaningful temperature data can be obtained. In such embodiments, the porous spacer 470 can be formed from a material that has high thermal conductivity. The temperature sensor can be connected via a lead 476 that can convey the temperature data to an external gage where the temperature can be observed. In some embodiments, the temperature sensor 474 can be in communication with feed back electronic circuitry that can disengage the first electrochemical cell 400a, the second electrochemical cell 400b and/or the battery pack 400, from the load. This can, for example, prevent the battery pack 40 from catastrophic failure.

While various embodiments of the system, methods and devices have been described above, it should be understood that they have been presented by way of example only, and not limitation. Where methods and steps described above indicate certain events occurring in certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

For example, although various embodiments have been described as having particular features and/or combination of components, other embodiments are possible having any combination or sub-combination of any features and/or components from any of the embodiments described herein. For example, although some embodiments of the electrochemical cells were described as being prismatic, in other embodiments, the electrochemical cells can be curved, bent, wavy, or have any other shape. In addition, the specific configurations of the various components can also be varied. For example, the size and specific shape of the various components can be different than the embodiments shown, while still providing the functions as described herein.

1. A device, comprising:
a first electrochemical cell disposed in a first container, the first container including a side wall having a first surface area;
a second electrochemical cell disposed in a second container, the second container including a side wall having a second surface area, the second surface area substantially equal to the first surface area; and
a porous spacer constructed from at least one porous material disposed between the first container and the second container, the porous spacer disposed and configured such that the porous spacer contacts the side wall of the first container and the side wall of the second container in a range of about 50% to about 100% of the first surface area and the second surface area, the porous spacer configured to:
limit the expansion of the first electrochemical cell and the second electrochemical cell by applying compressive force on at least one portion of the first surface area and the second surface area, and
expose at least one portion of the first surface area and the second surface area to a cooling medium.

2. The device of claim 1, wherein the porous spacer includes a cavity configured to receive a temperature sensor, the cavity positioned such that the temperature sensor is disposed in proximity of a central location of the first electrochemical cell and the second electrochemical cell.

3. The device of claim 1, wherein the porous spacer is disposed between the first container and the second container in a central portion of the first surface area and the second surface area.

4. The device of claim 1, wherein the porous spacer is constructed from steel wool.

5. The device of claim 1, wherein the porous spacer is integrally formed with at least one of the first container and the second container.

6. The device of claim 1, wherein the porous spacer is attached to at least one of the first container and the second container.

7. The device of claim 1, wherein the porous spacer is constructed from a porous elastic polymer.

8. The device of claim 1, wherein the porous spacer comprises porosity that is arranged at random.

9. The device of claim 1, wherein the porous spacer comprises porosity that is placed in a periodic arrangement structure.

10. A device, comprising:
a first electrochemical cell disposed in a first container, the first container including a side wall having a first surface area;
a second electrochemical cell disposed in a second container, the second container including a side wall having a second surface area, the second surface area substantially equal to the first surface area;
a first porous spacer constructed from at least one porous material disposed between the first container and the second container in a central portion of the first surface area and the second surface area, the first porous spacer disposed and configured such that the first porous spacer contacts the side wall of the first container and the side wall of the second container; and
a plurality of second porous spacers constructed from at least one porous material disposed between the first container and the second container, the plurality of second porous spacers disposed and configured such that each of the plurality of second porous spacers surround the first porous spacer and contacts the side wall of the first container and the side wall of the second container,
wherein the first porous spacer and the plurality of second porous spacers are configured to: limit the expansion of the first electrochemical cell and the second electrochemical cell by applying compressive force on a plurality of portions of the first surface area and the second surface area, and
expose a plurality of portions of the first surface area and the second surface area to a cooling medium.

11. The device of claim 10, wherein the plurality of second porous spacers are configured to limit expansion of the first electrochemical cell and the second electrochemical cell by applying compressive force on portions of the first surface area and the second surface area that are not in contact with the first porous spacer.

12. The device of claim 10, wherein the first porous spacer includes a cavity configured to receive a temperature sensor, the cavity positioned such that the temperature sensor is disposed in proximity of a central portion of the first electrochemical cell and the second electrochemical cell.

13. The device of claim 10, wherein the first porous spacer and the plurality of second porous spacers are constructed from steel wool.

14. The device of claim 10, wherein the first porous spacer and the plurality of second porous spacers comprise porosity that is arranged at random.

15. The device of claim 10, wherein the first porous spacer and the plurality of second porous spacers comprise porosity that is arranged periodically.

16. The device of claim 10, wherein the first porous spacer and the plurality of second porous spacers are constructed from a porous elastic polymer.

17. A device, comprising:
a first electrochemical cell disposed in a first container, the first container including a side wall having a first surface area;
a porous spacer constructed from at least one porous material disposed on the side wall of the first container and configured to contact about 50% to about 100% of the first surface area; and
a second electrochemical cell disposed in a second container, the second container including a side wall having a second surface area, the side wall of the second container disposed on the spacer such that the spacer contacts about 50% to about 100% of the second surface area, wherein the porous spacer is configured to:
limit the expansion of the first electrochemical cell and the second electrochemical cell by applying compressive force on at least one portion of the first surface area and the second surface area, and
expose at least one portion of the first surface area and the second surface area to a cooling medium.

18. The device of claim 17, where the porous spacer is disposed on the side wall of the first container such that the spacer is integrally formed with the first container.

19. The device of claim 17, wherein the side wall of the second container is disposed on the porous spacer such that the second container is integrally formed with the porous spacer.

20. The device of claim 17, wherein the porous spacer is disposed between the first container and the second container in a central portion of the first surface area and the second surface area.
